(19) United States
(12) Patent Application Publication
(10) Pub. No.: US 2025/0138762 A1
(43) Pub. Date: May 1, 2025

(54) IMAGE FORMING APPARATUS AND OPERATIONAL OBJECT DISPLAY METHOD

(71) Applicant: SHARP KABUSHIKI KAISHA, Sakai City (JP)

(72) Inventor: Mikiya OKADA, Sakai City (JP)

(21) Appl. No.: 18/925,532

(22) Filed: Oct. 24, 2024

(30) Foreign Application Priority Data
Oct. 31, 2023 (JP) 2023-187007

(51) Int. Cl. G06F 3/12

(52) U.S. Cl. CPC G06F 3/1253; G06F 3/1203; G06F 3/1284

(57) ABSTRACT

An image forming apparatus includes: a displayer that displays an operational screen of an image forming apparatus; and controllers that control execution of an input job, in which when a printing job is input, the controllers determine a display form of an operational object for receiving a stop instruction for that printing job, and display, on the operational screen, the operational object that is based on determined the display form.

### BACKGROUND OF THE INVENTION

### Field of the Invention

The present disclosure relates to an image forming apparatus, or the like.

### Description of the Background Art

During processing of a printing job such as a print job in image forming apparatus such as multifunction machines, that printing job may need to be stopped in some cases.

For example, as a prior art, such an image forming apparatus is known which can promptly interrupt printing processing in progress, by displaying an in-progress printing screen including a printing interruption button during the printing processing is in progress.

An object of the present disclosure is to provide an image forming apparatus, or the like, which can improve a user's operability.

### SUMMARY OF THE INVENTION

So as to solve the above-stated problems, an image forming apparatus according to the present disclosure includes: a displayer that displays an operational screen of the image forming apparatus; and one or more controllers that control execution of an input job, in which when a printing job is input, the controllers determine a display form of an operational object for receiving a stop instruction for that printing job, and display, on the operational screen, the operational object that is based on determined the display form.

A operational object display method according to the present disclosure includes: displaying an operational screen of an image forming apparatus; controlling execution of an input job; and when a printing job is input, determining a display form of an operational object for receiving a stop instruction for that printing job, and displaying, on the operational screen, the operational object that is based on determined the display form.

The present disclosure can provide an image forming apparatus, or the like, which can improve a user's operability.

### BRIEF DESCRIPTION OF THE DRAWINGS

FIG. 1 is an outer perspective view for explaining an overall configuration of a multifunction machine according to a first embodiment.

FIG. 2 explains a functional configuration of the multifunction machine according to the first embodiment.

FIG. 3 is a flowchart for explaining a flow of processing according to the first embodiment.

FIG. 4 is a flowchart for explaining a flow of processing according to the first embodiment.

FIG. 5 explains an operating example according to the first embodiment.

FIG. 6 explains an operating example according to the first embodiment.

FIG. 7 explains an operating example according to the first embodiment.

FIG. 8 explains an operating example according to the first embodiment.

FIG. 9 explains an operating example according to the first embodiment.

FIG. 10 explains an operating example according to the first embodiment.

FIGS. 11A and 11B each explain an operating example according to the first embodiment.

FIG. 12 explains an operating example according to the first embodiment.

FIG. 13 is a flowchart for explaining a flow of processing according to a second embodiment.

FIGS. 14A and 14B each explain an operating example according to the second embodiment.

### DESCRIPTION OF THE PREFERRED EMBODIMENTS

The following explains the embodiments of the present disclosure with reference to the accompanying drawings. Note that the following embodiments are examples for explaining the present disclosure, and the technical content of the explanation described in the scope of claims is not limited to the following description.

There is a type of conventional image forming apparatus, which prompts a user to select a printing job, such as a print job, to be stopped and to select a printing stop button for receiving input of a stop instruction via an operational screen, such as a job management screen, if processing related to the printing job is to be stopped during processing of the printing job.

In the image forming apparatus having such a configuration, it takes users many troubles to express their intention to stop the printing job (to select a printing job to be stopped and select a printing stop button). Therefore, the image forming apparatus is nowhere excellent in usability for users desiring to immediately stop a printing job.

By the way, many users select an image forming apparatus having a screen size of about 5 inches (e.g., WVGA (800*480 px)), for example, depending on the budget or purposes. With a screen size of about 10 inches (e.g., WSVGA (1024*600 px)), there may be no problem displaying an operational object such as a printing stop button (hereinafter, the stopping object is referred to as “printing stop object”). However, in a type of image forming apparatus having a small screen size of about 5 inches, ways of displaying an operational object such as a printing stop button has to be devised so as not to have a cumbersome screen configuration.

The present disclosure realizes an image forming apparatus, or the like, which can improve a user's operability during inputting of a stop instruction for a printing job, by way of the following embodiments.

### 1. First Embodiment

The first embodiment is an embodiment which includes: a displayer that displays an operational screen of a multifunction machine being an image forming apparatus; and a controller that controls execution of an input job, in which, when a printing job is input, the controller determines a display form of an operational object for receiving a stop instruction for that printing job, and displays the operational object on the operational screen.

### 1.1. Functional Configuration

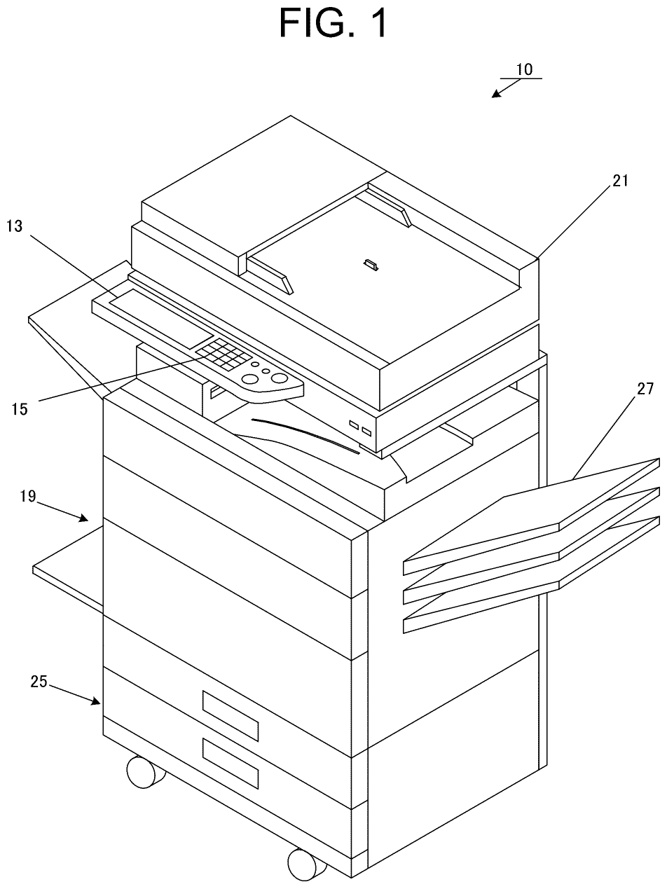

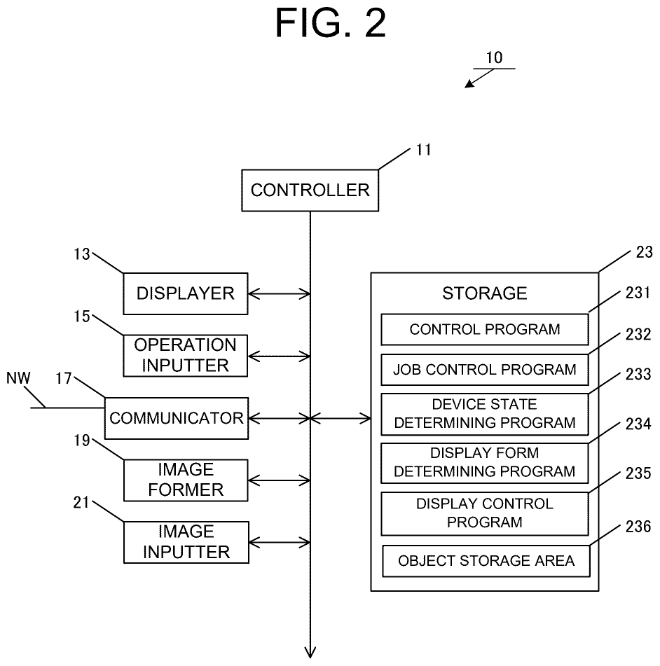

FIG. 1 is an outer perspective view for explaining an overall configuration of a multifunction machine 10 according to a first embodiment. FIG. 2 explains a functional configuration of the multifunction machine 10, as an image forming apparatus, according to the first embodiment.

The multifunction machine 10 is an exemplary image forming apparatus which can realize, by a single body, various types of jobs such as printing, copying, facsimile, and image transmission. Here, in the present disclosure, a job which forms, onto recording paper, etc., an image based on input image information, such as by printing or copying, is referred to as a printing job. Especially, the first embodiment deals with a print job for image-forming, onto recording paper, image information which is received as a printing job from an external terminal device, not illustrated (e.g., information processing device such as a personal computer (PC), a portable telephone, a smartphone, and a tablet, coupled by wire or wirelessly).

The multifunction machine 10 includes a controller 11, a displayer 13, an operation inputter 15, a communicator 17, an image former 19, an image inputter 21, and a storage 23.

The controller 11 controls the entire multifunction machine 10. The controller 11 is constituted by one or a plurality of processing devices (e.g., central processing unit (CPU), system on chip (SoC), or the like). The controller 11 realizes its function by reading various types of programs stored in the storage 23 and executing the programs.

The displayer 13 is a display device that displays various types of information for users, or the like. The displayer 13 can be configured by a liquid crystal display (LCD), an organic electro-luminescence display (EL), or the like, for example. The displayer 13 displays an operational screen (e.g., a later-described home screen, log-in screen, job setting screen, etc.) depending on the state of the multifunction machine 10.

The operation inputter 15 is an input device to receive inputting of information from a user, or the like. The operation inputter 15 can be configured by various types of input devices, such as an operational key such as a hard key or a soft key, and a button. Note that the operation inputter 15 can be configured as a touch panel onto which inputting is possible via the displayer 13. When the operation inputter 15 is configured as a touch panel, the operation inputter 15 can detect a user's touch operation with respect to a display object displayed via the displayer 13. In this case, as an input method for a touch panel, general methods, such as by way of resistive film, infrared, electromagnetic induction, and electrostatic capacity, can be adopted.

The communicator 17 includes either wired or wireless interface or both of wired and wireless interfaces, for communicating with other devices (external terminal device not illustrated) via a network NW, such as a local area network (LAN), a wide area network (WAN), the Internet, a telephone line, and a facsimile line. In addition, for example, the communicator 17 may include a (near field) wireless communication technology, such as Bluetooth (registered trademark), near field communication (NFC), Wi-Fi (registered trademark), ZigBee (registered trademark), Infrared Data Association (IrDA), and wireless universal serial bus (USB).

The image former 19 feeds recording paper from a paper feed tray 25, forms an image based on image information on the recording paper, and ejects the recording paper onto a paper ejector 27. The image former 19 can be configured by an electrographic laser printer, or the like. In this case, the image former 19 forms an image using toner supplied from a toner cartridge, not illustrated, according to toner colors (e.g., cyan, magenta, yellow, black, etc.).

The image inputter 21 scans a document, thereby generating image information. The image inputter 21 can be configured as a scanner device, which includes an image sensor such as a charge coupled device (CCD) and a contact image sensor (CIS), an automatic document reader (auto document feeder: ADF), and a flatbed for mounting thereon a document to read the document. The image inputter 21 is not limited in construction as long as having a configuration that enables generation of image information by reading light reflected from the document image by means of an image sensor. Note that the image inputter 21 can also be configured as an interface capable of obtaining document data stored in an external storage medium such as a USB memory, or a print job transmitted from an external terminal device.

The storage 23 is one or a plurality of storage devices storing therein various types of programs and various types of data necessary for operation of the multifunction machine 10. The storage 23 can be configured by a storage device such as a random access memory (RAM), a hard disk drive (HDD), a solid state drive (SSD), a read only memory (ROM), for example.

In the first embodiment, the storage 23 stores therein a control program 231, a job control program 232, a device state determining program 233, a display mode determining program 234, and a display control program 235, and secures an object storage area 236.

The control program 231 is a program read by the controller 11 when performing an integrated control on the multifunction machine 10. The controller 11, having read the control program 231, controls driving of hardware such as the displayer 13, the operation inputter 15, the communicator 17, the image former 19, and the image inputter 21.

The job control program 232 is a program read by the controller 11 when executing a printing job related to printing or copying, or a job related to facsimile or image transmission, being a later-described specific job. The controller 11, having read the job control program 232, transitions to a job mode to execute each job (print mode, copy mode, facsimile mode, or image transmission mode), and executes that job. Note that, when executing a job, the controller 11 displays, on a touch panel configured as the operation inputter 15 (displayer 13), a job execution screen as an operational screen for receiving selection of set values or functions necessary for execution of a job from a user, as necessary. The controller 11 executes each job, based on the set values or functions received via the job execution screen. Note that when the controller 11, having read the job control program 232, receives selection of a printing stop object to receive an instruction to stop the printing job, displayed via the operational screen such as the job execution screen, the controller 11 stops the printing job under execution. The processing related to stopping of a printing job is described later.

The device state determining program 233 is a program read by the controller 11 when having received the printing job from an external terminal device, etc., not illustrated. The controller 11, having read the device state determining program 233, determines the state of the device when the printing job is received. The controller 11 determines, whether the multifunction machine 10 is in any of states of: a non-job-processing state in which no specific job is being processed (executed) and, for example, in which a home screen, a user authentication screen, etc. is being displayed on a touch panel; a job processing state in which a specific job is being processed (executed) and in which a job execution screen related to the specific job is being displayed; or a non-operation state in which the operational screen on display on the touch panel is not being operated. In this case, the controller 11 can determine the state of the multifunction machine 10, based on the content on the operational screen on display on the touch panel, the transitioned job mode, or whether there is a touch operation on the touch panel. Note that the present disclosure explains, as a specific job, a job related to transmission of image information, such as facsimile or image transmission.

The display mode determining program 234 is a program read by the controller 11 when a display form of a printing stop object for receiving an instruction to stop a printing job is determined. The controller 11, having read the display mode determining program 234, determines a display form of a printing stop object for receiving an instruction to stop a printing job, depending on the state of the multifunction machine 10 determined by reading the device state determining program 233 (i.e. any of the non-job-processing state, the job processing state, or the non-operation state). Specifically, if determining that the multifunction machine 10 is in the non-job-processing state, the controller 11 determines the display form of the printing stop object to be the button displaying the name of the printing stop object (printing stop object name), such as “printing stop”, for example. On the other hand, if determining that the multifunction machine 10 is in the job processing state, the controller 11 determines the display form of the printing stop object to be the icon. By the way, if determining that the multifunction machine 10 is in the non-operation state, the controller 11 determines to display a message screen including the printing stop object by overlaying it on the operational screen.

The display control program 235 is a program read by the controller 11 when performing display control on the operational screen by adjusting a display position, a display size, etc. of various types of content displayed on the touch panel. The controller 11, having read the display control program 235, performs display control on an input object for receiving a user's input of various types of set values, a selection object for receiving selection of set values, functions, etc., a display object to display set content and device state, or the like. In addition, the controller 11 performs control to display the printing stop object which is based on the display mode determined by reading of the display mode determining program 234, onto the later-described first display area or second display area.

The object storage area 236 is a storage area to store image information of an object related to various types of content to be displayed on the touch panel.

### 1.2. Flow of Processing

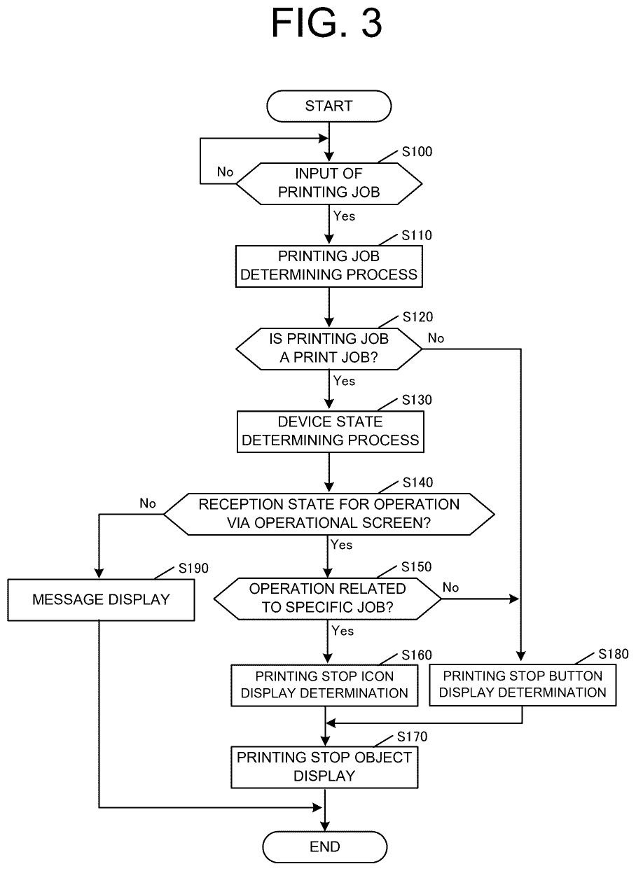

Next, the following explains a flow of processing according to the first embodiment. FIG. 3 is a flowchart for explaining processing from input of a printing job to display of a printing stop object. Note that the processing explained with reference to FIG. 3 is processing performed by the controller 11 by reading the job control program 232, the device state determining program 233, the display mode determining program 234, the display control program 235, or the like.

First, the controller 11 determines whether input of a printing job is received (step S100). If it is determined that input of a printing job is received, the controller 11 determines whether the received printing job is a print job received from an external terminal device, not illustrated, or a copy job received via the image inputter 21 (step S110). On the other hand, if it is determined that input of a printing job is not received, the controller 11 waits until receiving input of a printing job (step S100; No).

As a result of the determination processing on a printing job, if it is determined that the received printing job is a print job, the controller 11 determines the state of the multifunction machine 10 (step S120; Yes→step S130). On the other hand, if it is determined that the received printing job is not a print job but is a copy job, the controller 11 determines the display form of the printing stop object for receiving an instruction to stop the printing job, to be a button displaying the printing stop object name, such as “printing stop” (step S120; No→step S180). Subsequently, the controller 11 displays the “printing stop” button as the printing stop object on the later-described second display area, and ends the processing (step S170).

As a result of determination of a device state, if it is determined that the device state of the multifunction machine 10 is a reception state for operation via the operational screen, the controller 11 then determines whether the operation is an operation related to a specific job (step S140; Yes→step S150).

If the controller 11 determines that the operation received via the operational screen is an operation related to a facsimile job or an image transmission job, which is a specific job, i.e., if the controller 11 determines that the operational screen on display on the touch panel is an operational screen related to a facsimile job or an image transmission job, and that the state of the multifunction machine 10 is a job processing state, the controller 11 determines the display form of the printing stop object to be the icon (step S150; Yes→step S160). Then, the controller 11 displays the icon as the printing stop object, on the later-described first display area, and ends the processing (step S170).

On the other hand, if the controller 11 determines that the operation received via the operational screen is not an operation related to a facsimile job or an image transmission job, as a specific job, i.e., if the controller 11 determines that the operational screen on display on the touch panel is not an operational screen related to a facsimile job or an image transmission job, and that the state of the multifunction machine 10 is a non-job-processing state, the controller 11 determines the display form of the printing stop object, to be a button displaying the printing stop object name, such as “printing stop” (step S150; No→step S180). Then, the controller 11 displays the “printing stop” button as the printing stop object on the later-described first display area, and ends the processing (step S170).

By the way, as a result of determination of the device state, if it is determined that the state of the multifunction machine 10 is a non-operation state which is not a reception state for operation via the operational screen, the controller 11 displays the message screen including the printing stop object by overlaying it on the operational screen, and ends the processing (step S140; No→step S190).

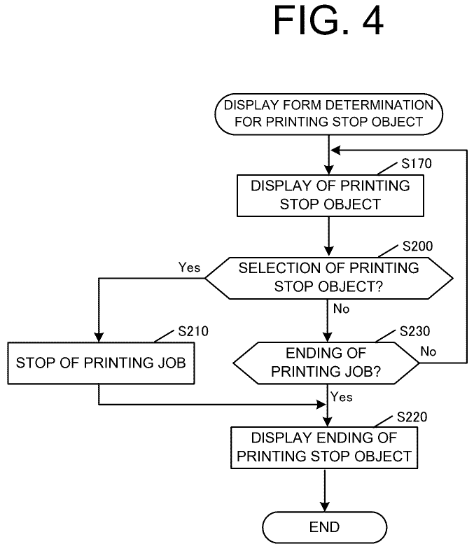

Next, the processing from display of a printing stop object to display ending for the printing stop object is explained with reference to the flowchart of FIG. 4. Note that the processing explained with reference to FIG. 4, is processing executed by the controller 11 by reading the job control program 232, the display control program 235, or the like.

In step S170 in FIG. 4, when having displayed the printing stop object, the controller 11 determines whether the displayed printing stop object is selected by a user (step S170→step S200). If it is determined that the printing stop object is selected by a user, the controller 11 stops the processing related to that printing job (step S200; Yes→step S210). Subsequently, the controller 11 ends the display of the printing stop object, and ends the processing (step S220).

On the other hand, in step S200, if it is determined that the printing stop object is not selected by a user, the controller 11 determines whether that printing job has been ended (step S200; No→step S230). If it is determined that the printing job has not been ended, the controller 11 returns the processing to step S170, and continues displaying the printing stop object (step S230; No→step S170). On the other hand, if it is determined that the printing job has been ended, the controller 11 ends the display of the printing stop object, and ends the processing (step S230; Yes→step S220).

### 1.3. Operating Example

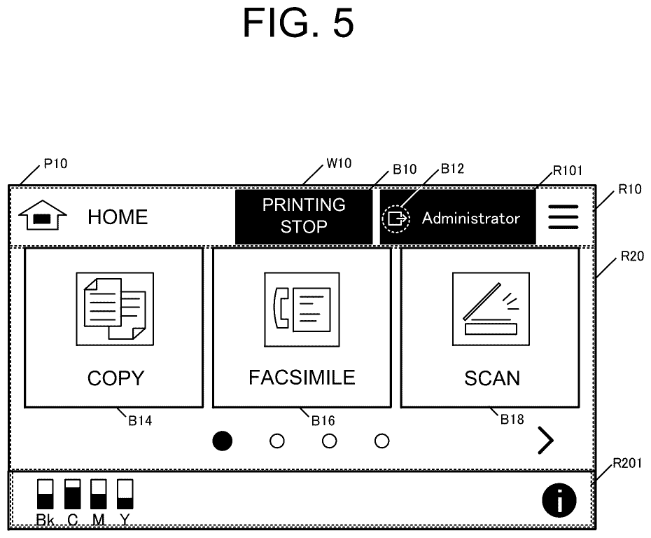

Next, an operating example according to the first embodiment is explained. FIG. 5 is an example of a display configuration of a home screen W10 displaying a “printing stop” button B10 as the printing stop object for receiving stopping of the printing job. Note that FIG. 5 is an operating example corresponding to the processing of step S150 (; No)→step S180→step S170 in FIG. 3, and is an example of a case in which the multifunction machine 10 is in the non-job-processing state.

The home screen W10 is an example of the operational screen to be displayed on the touch panel P10 by the controller 11 when the multifunction machine 10 is in the non-job-processing state. For example, the home screen W10 is an operational screen to be displayed on the touch panel P10 to receive a user operation input when a user authentication to the multifunction machine 10 is successful.

The home screen W10 includes a system area R10 as the first display area, and a function menu area R20 as the second display area. The system area R10 is a display area to display information related to system setting of the multifunction machine 10. The system area R10 includes a “printing stop” button B10 and a log-in user name display area R101.

The “printing stop” button B10 is an operational object (hereinafter referred to as “printing stop object”) to receive a stop instruction for printing processing related to an input print job. Upon receiving selection of “printing stop” button B10 by a user, the controller 11 executes stop processing for the printing job on and after step S200 in FIG. 4.

The log-in user name display area R101 is a display area to display a user name (“Administrator” in the example of FIG. 5) of a user who has logged in to the multifunction machine 10. Note that it is also possible to display, in the log-in user name display area R101, a log-out button B12 to receive a user's instruction to log out from the multifunction machine 10, as well.

The function menu area R20 is a display area to display a job selection button to receive selection of a job and various types of processing desired by a user. For example, a user can display a job execution screen for execution of a job related to a copy mode, by selecting a copy button B14 included in the function menu area R20. In addition, a user can display a job execution screen for execution of a job related to a facsimile mode, by selecting a facsimile button B16 included in the function menu area R20. Further, a user can display a job execution screen for execution of a job related to a scan mode, by selecting a scan button B18 included in the function menu area R20.

Note that the function menu area R20 may include, in a part of the display area, a fixed area R201 to display information regarding a remaining amount of consumables such as toner, paper, etc., or an icon to receive an instruction to display device information, as in the example of FIG. 5.

As in the example of FIG. 5, the home screen W10, as the operational screen according to the present disclosure, is divided into: the system area R10, as the first display area; and the function menu area R20, as the second display area, which is greater in display area than the system area R10, depending on the display purposes.

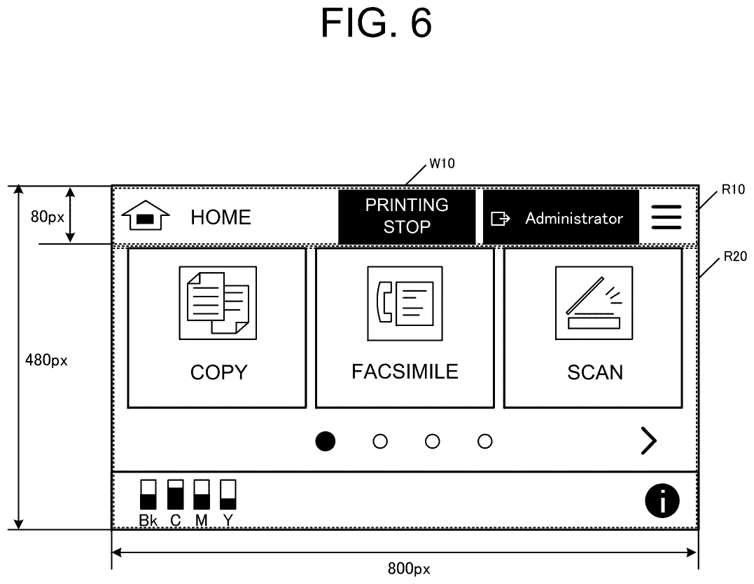

Here, with reference to FIG. 6, the following explains the size relationship in display area between the system area R10 and the function menu area R20. According to the present disclosure, when the total display area of the home screen W10 (touch panel P10) is assumed to be 800*480 px=384000 px, the display area of the system area R10 is set as 80*800 px=64000 px, for example. In this case, the ratio of the display area of the system area R10 to the total display area of the home screen W10 is 16.7%, which corresponds to 20% or less display area. By setting the display area ratio of the system area R10 to the home screen W10 to be 20% or less, a function menu area R20 having 80% or more display area can be allocated. As a result, even with a touch panel having a small screen size of about 5 inches, necessary information related to selection of a job (mode) can be displayed to a user without omission.

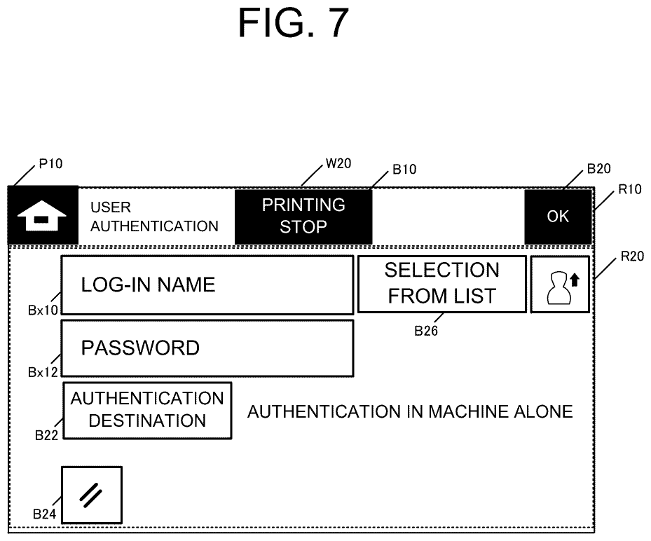

FIG. 7 is an example of a display configuration in which the “printing stop” button B10 as the printing stop object to receive stop of the printing job is displayed on the user authentication screen W20. Note that FIG. 7 is an operating example corresponding to the processing of step S150 (; No)→step S180→step S170 in FIG. 3, and is an other example of a case in which the multifunction machine 10 is in the non-job-processing state.

The user authentication screen W20 is an example of the operational screen to be displayed on the touch panel P10 by the controller 11 when the multifunction machine 10 is in the non-job-processing state. For example, the user authentication screen W20 is an operational screen to be displayed on the touch panel P10 to receive a user operation input at the time of power on, standby, waking from sleep mode, etc. Note that the configuration which is the same as that explained with reference to FIG. 5 is assigned the same reference numeral, and the explanation thereof is omitted.

The system area R10 related to the user authentication screen W20 includes a “printing stop” button B10 and an OK button B20.

The OK button B20 is a button to receive an instruction to confirm the content input in the function menu area R20.

The function menu area R20 includes a log-in name input box Bx10, a password input box Bx12, an authentication destination selection button B22, a reset button B24, and a selection-from-list button B26.

The log-in name input box Bx10 is an input box to receive input of a log-in user name of a user attempting to log in to the multifunction machine 10.

The password input box Bx12 is an input box to receive input of a log-in password associated with the log-in user name.

The controller 11 receives, from a user, input of information related to user authentication, such as log-in user name, log-in password, etc., and performs user authentication. In this case, the controller 11 can perform the user authentication by comparing a combination of log-in user name and log-in password input by a user to a combination of log-in user name and log-in password registered in the own device in advance.

The authentication destination selection button B22 is a button to receive selection of an authentication destination of the user authentication. As described earlier, the user authentication can be performed using a combination of log-in user name and log-in password registered in the own device, or may be performed via an authentication server separately provided outside, for example. A user can select the user authentication destination from among the own device or an outside authentication server, via the authentication destination selection button B22.

The reset button B24 is a button to receive an instruction to rest the information input to the log-in name input box Bx10, the password input box Bx12, or the like. Upon receiving, from a user, a selection instruction with respect to the reset button B24, the controller 11 resets the information input to the log-in name input box Bx10, or the like.

For example, the selection-from-list button B26 is a button to receive selection of a log-in user via an address book, or the like, if the multifunction machine 10 manages log-in user names using such address book, or the like. Upon receiving, from a user, a selection instruction with respect to the selection-from-list button B26, the controller 11 can display a list of log-in user names, and receive selection of any log-in user name from one or a plurality of log-in user names displayed in the list.

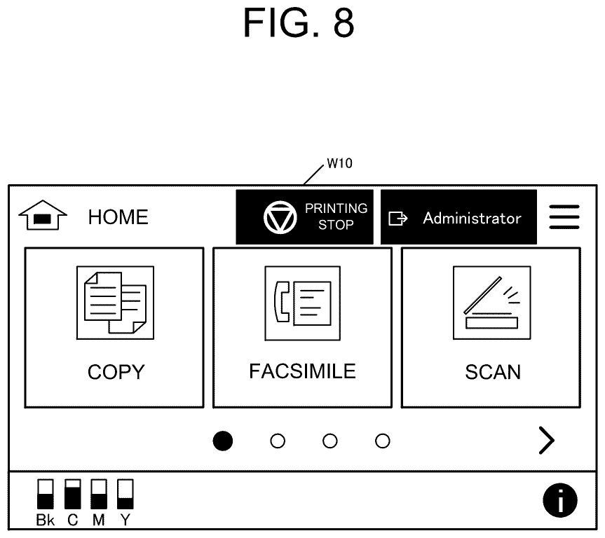

By the way, in FIG. 5 and FIG. 7, the “printing stop” button B10 which displays a printing stop object name (printing stop) was exemplified as a printing stop object to receive stop of a printing job. However, as illustrated in FIG. 8, the printing stop object name may be displayed by assigning it an icon which performs an abbreviated display of the printing stop object, as explained with reference to the next drawing. By displaying the printing stop object name assigned with an icon, a user can have a clear understanding of instructed content indicated by the icon.

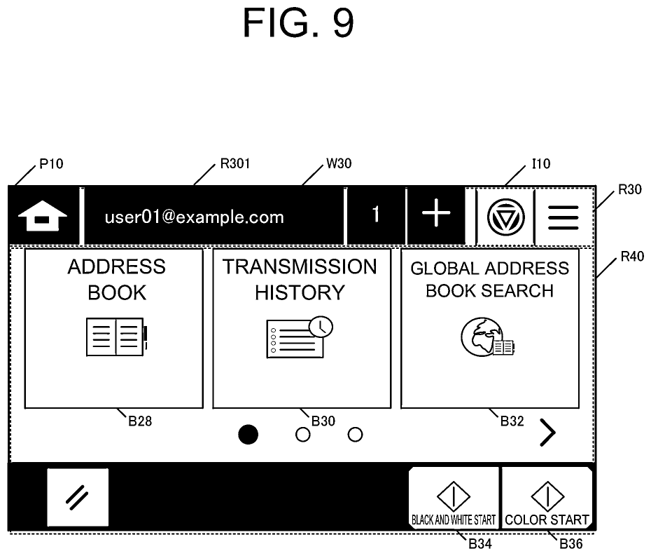

FIG. 9 is an example of a display configuration in which an icon as a printing stop object to receive a stop instruction for a printing job is displayed on the job execution screen W30 related to the image transmission job being a specific job. Note that FIG. 9 is an operating example corresponding to the processing of step S150 (; Yes)→step S160→step S170 in FIG. 3, and is an example of a case in which the multifunction machine 10 is in the job processing state.

The job execution screen W30 is an example of the operational screen to be displayed on the touch panel P10 by the controller 11 when the multifunction machine 10 is in the job processing state related to an image transmission job. The job execution screen W30 is an operational screen to be displayed on the touch panel P10 to receive a user operation input when selection of the scan button B18 on the home screen W10, as illustrated in FIG. 5, is received.

The job execution screen W30 includes a system area R30 as the first display area and a function menu area R40 as the second display area.

The system area R30 includes a destination display area R301 and a “printing stop” icon I10. The destination display area R301 is a display area to display, during the image transmission job, an e-mail address (e.g., user01@example.com) as a transmission destination of image information, which is selected in response to selection of the address book button B28, the transmission history button B30, or the global address book search button B32, which are included in the function menu area R40.

The “printing stop” icon I10 is a printing stop object to receive a stop instruction for printing processing related to an input print job. The “printing stop” icon I10 is an abbreviated display of the “printing stop” button B10 in FIG. 5, or the like. Upon receiving selection of “printing stop” icon by a user, the controller 11 executes stop processing for the printing job on and after step S200 in FIG. 4.

The function menu area R40 includes: an address book button B28 to receive selection of a transmission destination regarding image transmission from a user; a transmission history button B30; a global address book search button B32; and a black and white start button B34 and a color start button B36 to receive an instruction to execute image transmission.

The address book button B28 is a button to receive selection of a transmission destination from the address book managed by the multifunction machine 10. Upon receiving a selection instruction with respect to address book button B28, the controller 11 displays the address book managed by the multifunction machine 10, and receives selection of a transmission destination from a user.

The transmission history button B30 is a button to receive selection of a transmission destination from a transmission history of jobs executed as image transmission jobs. Upon receiving a selection instruction with respect to the transmission history button B30, the controller 11 displays the transmission history, and receives selection of a transmission destination from a user.

The global address book search button B32 is a button to receive selection of a transmission destination from the address book managed by an external network, or the like, which is different from the multifunction machine 10. Upon receiving a selection instruction with respect to the global address book search button B32, the controller 11 displays the address book managed by the external network, or the like, and receives selection of a transmission destination from a user.

The black and white start button B34 is a button to receive an instruction to execute image transmission by a black and white image. The color start button B36 is a button to receive an instruction to execute image transmission by a color image. Upon receiving a selection instruction with respect to the black and white start button B34 or the color start button B36, the controller 11 executes a job related to image transmission.

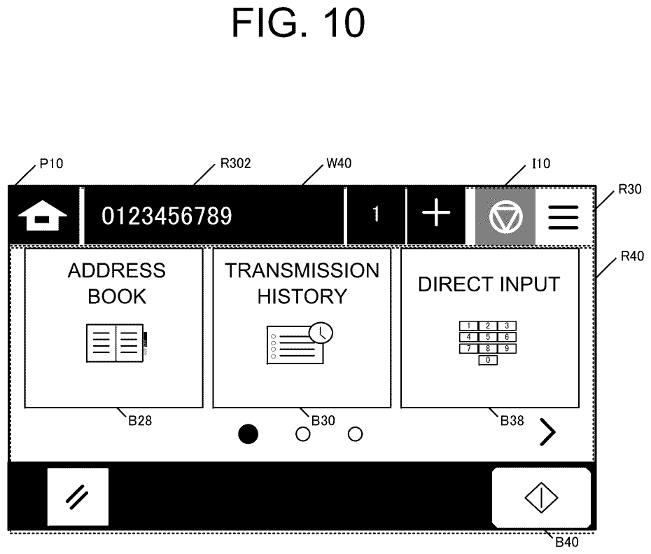

FIG. 10 is an example of a display configuration in which an icon as a printing stop object to receive a stop instruction for a printing job is displayed on the job execution screen W40 related to a facsimile job being a specific job. Note that FIG. 10 is an operating example corresponding to the processing of step S150 (; Yes)→step S160→step S170 in FIG. 3, and is an other example of a case in which the multifunction machine 10 is in the job processing state.

The job execution screen W40 is an example of the operational screen to be displayed on the touch panel P10 by the controller 11 when the multifunction machine 10 is in the job processing state related to a facsimile job. The job execution screen W40 is an operational screen to be displayed on the touch panel P10 to receive a user operation input when selection of the facsimile button B16 on the home screen W10, as illustrated in FIG. 5, is received. Note that the configuration which is the same as that explained with reference to FIG. 9 is assigned the same reference numeral, and the explanation thereof is omitted.

The job execution screen W40 includes a system area R30 as the first display area and a function menu area R40 as the second display area.

The system area R30 includes a destination display area R302 and a “printing stop” icon I10. The destination display area R302 is a display area to display, during the facsimile job, a facsimile number (e.g., 0123456789) as a transmission destination of image information, which is selected in response to selection of the address book button B28, the transmission history button B30, or a direct input button B38, which are included in the function menu area R40.

The function menu area R40 includes: an address book button B28 to receive selection of a transmission destination related to facsimile transmission from a user; a transmission history button B30; a direct input button B38; and a start button B40.

The direct input button B38 is a button to receive direct input of a facsimile number as a transmission destination. Upon receiving a selectin instruction with respect to the direct input button B38, the controller 11 displays a software keyboard, etc., not illustrated, and receives a facsimile number as a transmission destination from a user. The start button B40 is a button to receive an instruction to execute facsimile transmission. Upon receiving a selection instruction with respect to the start button B40, the controller 11 executes a job related to the facsimile transmission.

The job execution screen W30 related to an image transmission job illustrated in FIG. 9 and the job execution screen W40 related to a facsimile job illustrated in FIG. 10 display, on the system area R30 the first display area, the “printing stop” icon I10 as the printing stop object. In the job processing state in which a specific job such as an image transmission job or a facsimile job is being executed, the destination display area R301 or R302, for displaying transmission destinations of these jobs, is displayed on the system area R30, which restricts the display area for displaying a printing stop object.

However, according to the first embodiment, even in the job processing state in which such a specific job is being executed, such control is performed to display the printing stop object as the “printing stop” icon I10. Therefore, input of a stop instruction for a printing job can be received without affecting content displayed on the function menu area R40.

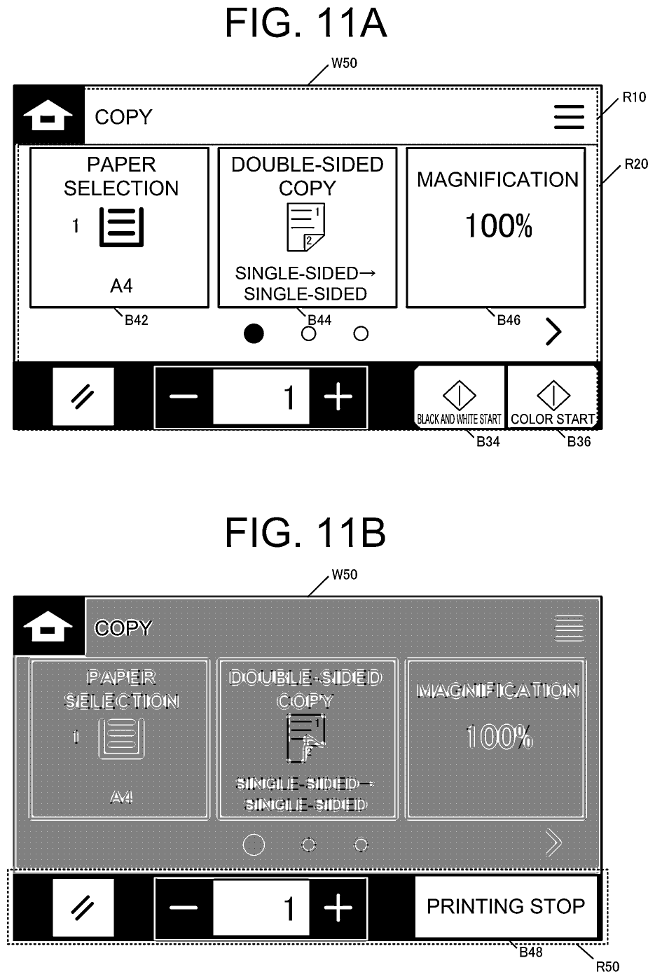

FIGS. 11A and 11B each explain a “printing stop” button B48 displayed as a printing stop object by the controller 11 when the received printing job is determined to be a copy job. FIGS. 11A and 11B are each an operating example corresponding to the processing of step S120 (; No)→step S180 in FIG. 3.

FIG. 11A is an example of a display configuration of the job execution screen W50 related to a copy job. The job execution screen W50 related to a copy job includes a system area R10 as the first display area and a function menu area R20 as the second display area.

The function menu area R20 includes a setting button for receiving input of various set (values) related to execution of a copy job. FIG. 11A illustrates an example in which the paper selection button B42, the double-sided copy button B44, and the magnification button B46, as example of the setting button, are displayed on the function menu area R20. Note that the setting button displayed on the function menu area R20 is not limited to the paper selection button B42, the double-sided copy button B44, or the magnification button B46, and can include such a setting button as being related to reading setting regarding reading of a document image, or finishing setting including whether to staple, for example, and can be modified as necessary by a user.

When the input printing job is a copy job, as illustrated in FIG. 11B, the controller 11 displays the “printing stop” button B48 displayed as the printing stop object, by overlaying it on the display position for the black and white start button B34 and the color start button B36 illustrated in FIG. 11A. During this process, it is preferable to restrict any inputting by a user via the system area R10 and the function menu area R20, by graying out the area other than the area R50 which includes the “printing stop” button B48. In this way, when the received printing job is a copy job, by displaying the “printing stop” button B48 on the job execution screen W50 in an identifiable and selectable manner, any user input error (setting error) can be prevented before selection of the “printing stop” button B48.

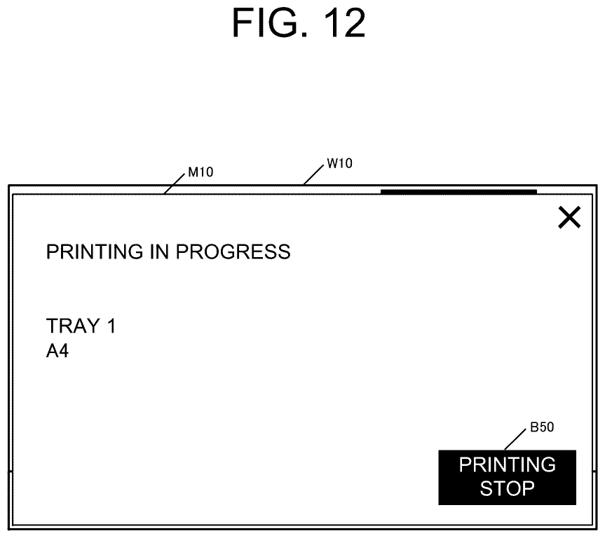

FIG. 12 illustrates an example in which a message screen M10 including the “printing stop” button B50 is displayed by overlaying it on the home screen W10. Note that FIG. 12 is an operating example corresponding to the processing of step S140 (; No)→step S190 in FIG. 3, and is an example of a case in which the multifunction machine 10 is in the non-operation state.

When the multifunction machine 10 is in the non-operation state, it can be estimated that there is no user to operate the operational screen such as the home screen W10, for example. In this case, the operation via the operational screen will not be delayed even if the message screen M10 including the “printing stop” button B50 is displayed by overlaying it over the entire home screen W10. In fact, by displaying the message screen M10 including the “printing stop” button B50 over the entire operational screen, it notifies a user having transmitted a print job to the multifunction machine 10 or a user existing near the multifunction machine 10.

As described so far, according to the first embodiment, when the received printing job is a print job, the display form of the operational object for receiving the stop instruction for the print job can be determined depending on the device state of the multifunction machine. For example, when in the job processing state in which a specific job is being executed, the multifunction machine according to the first embodiment can determine the display form of the printing stop object to be the icon, and display it on the system area as the first display area. On the other hand, when the device is in the non-job-processing state in which no specific job is being executed, the display form of the printing stop object can be determined to be a button displaying the printing stop object name, such as “printing stop”, and it can be displayed on the system area as the first display area.

As described so far, according to the first embodiment, even when there is a restriction on the display area of the operational screen related to a specific job, the printing stop object can be displayed in an appropriate display mode without degrading a user's operability with respect to the operational screen. Accordingly, the user can issue a stop instruction for the input printing job without delay, which improves the operability related to inputting of the stop instruction for the printing job.

### 2. Second Embodiment

The second embodiment is an embodiment in which, after the display form of a printing stop object is determined in the first embodiment, the display of that printing stop object is restricted, and when a user's operation to the operational screen is detected, the printing stop object is displayed.

The functional configuration of the multifunction machine according to the second embodiment may be the same as the functional configuration of the multifunction machine 10 according to the first embodiment. Therefore, the explanation of the functional configuration of the multifunction machine 10 according to the second embodiment is omitted.

### 2.1. Flow of Processing

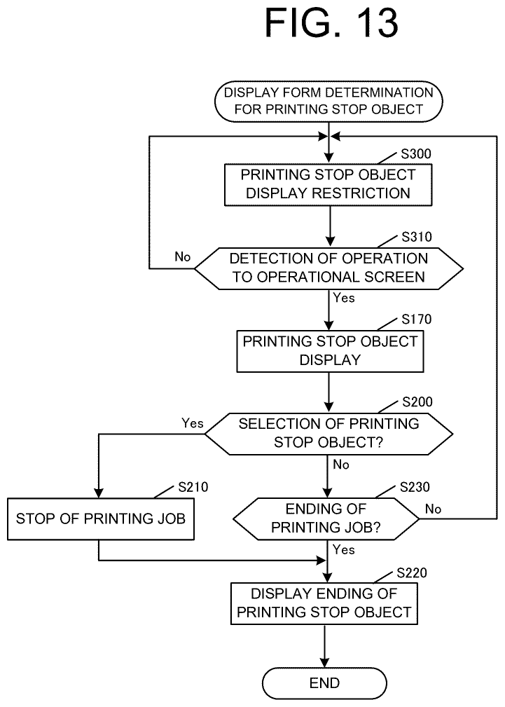

The flow of processing regarding determination of the display form of the printing stop object may be the same as the processing explained with reference to the flowchart in FIG. 3 according to the first embodiment. In addition, the processing regarding the display control on the printing stop object may result by replacing the flowchart of FIG. 4 with the flowchart of FIG. 13. Note that the processing on or after step S170 of FIG. 13 is the same as the processing in the flowchart of FIG. 4, and therefore the same reference numerals are assigned thereto and the explanation is omitted.

When having determined the display form of the printing stop object, the controller 11 restricts the display of the printing stop object which is based on the determined display mode (step S300).

Then, the controller 11 determines whether a user's operation with respect to the operational screen is detected (step S310). When having determined that a user's operation with respect to the operational screen is detected, the controller 11 displays the printing stop object (step S310; Yes→step S170). On the other hand, when having determined that no user's operation with respect to the operational screen is detected, the controller 11 maintains restrictions on the display of the printing stop object (step S310; No→step S300).

### 2.2. Operating Example

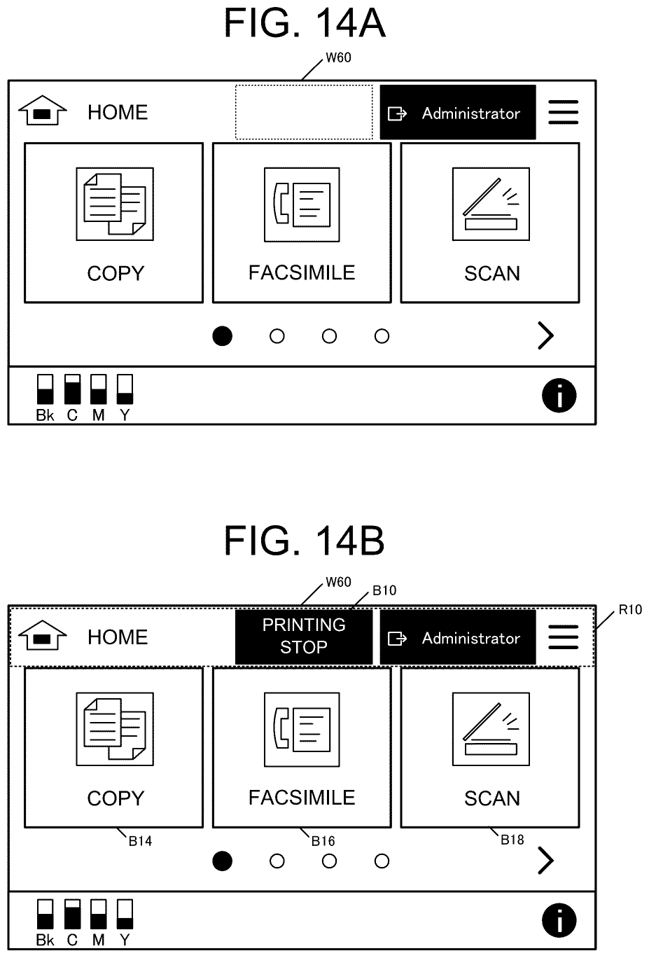

FIGS. 14A and 14B each explain an operating example according to the second embodiment. FIG. 14A explains an operation example corresponding to the processing of step S300 in FIG. 13. FIG. 14B explains an operation example corresponding to the processing of step S310 (; Yes)→step S170 in FIG. 13.

FIG. 14A is an example of a display configuration of a home screen W60 on which display of the printing stop object is restricted. According to the second embodiment, display of the printing stop object which is based on the determined display mode is restricted after determination of the display form of the printing stop object with respect to the input print job.

FIG. 14B illustrates a state in which the controller 11 displays the “printing stop” button B10 as the printing stop object on the system area R10, when a user's touch operation, etc. with respect to the home screen W60 (e.g., selection of the copy button B14, etc.) is detected.

According to the second embodiment, when no user's operation with respect to the operational screen is detected, the controller 11 restricts display of the printing stop object such as the “printing stop” button and the “printing stop” icon. Then, when a user's operation with respect to the operational screen is detected, the controller 11 displays the printing stop object on the operational screen. Therefore, in addition to the effect achieved by the first embodiment, the second embodiment can achieve an effect of preventing a user not desiring a printing stop, from uselessly selecting the “printing stop” button or the “printing stop” icon, as the printing stop object.

The present disclosure is not limited to each embodiment described above, and can be modified in various manners. That is, embodiments obtained by combining the technical means modified as necessary within the scope not departing from the gist of the present disclosure are also included in the technical scope of the present disclosure.

In addition, if the embodiments were described separately for facilitating explanation, it is needless to say that such embodiments can be implemented in combination within the technically possible scope.

The program operating in each device according to the embodiments is a program to control a CPU, etc. to realize the functions of the above-described embodiments (program to function the computer). The information dealt with in these devices is temporarily stored in a temporary storage device (e.g., RAM) during processing thereof, thereafter stored in a storage device such as various types of read only memories (ROM) or HDDs, and read, modified, and writing is performed thereto as necessary by a CPU.

Here, computer readable non-transitory recording medium recording thereon a program in an information processing device may be any of semiconductor media (e.g., ROM or non-volatile memory card, etc.), optical recording media, magneto-optical recording media (e.g., digital versatile disc (DVD), magneto optical disc (MO), mini disc (MD), compact disc (CD), Blu-ray (registered trademark) Disc (BD) etc.), magnetic recording media (e.g., magnetic tape, flexible disk, etc.). In this case, not only the functions of the above-described embodiments are realized by reading of a program recorded on a recording medium by a computer of an information processing device and executing of the program by the computer; but also the functions of the present disclosure are realized by cooperative processing with the operating system, the other application programs, etc., based on the instruction by the program.

For distribution in the market, the program can either be distributed by being stored on a portable recording medium, or be transferred to a server computer connected via the Internet or other networks. In this case, it is needless to say that the storage device of the server computer is included in the scope of the present disclosure.

Each functional block or various features of the device used in the above-described embodiments may also be implemented or executed in an electric circuit, e.g., an integrated circuit or a plurality of integrated circuits. The electric circuit, designed to realize the functions described in the present specification, may include a general-purpose processor, a digital signal processor (DSP), an application-specific integrated circuit (ASIC), a field-programmable gate array (FPGA), or other programmable logic devices, discrete gates or transistor logics, discrete hardware components, or a combination of them. The general-purpose processor may be a microprocessor, or may be a conventional processor, a controller, a microcontroller, or a state machine. The aforementioned electric circuit may be composed of digital circuits or analog circuits. Additionally, with advancements in semiconductor technology, if a technology to integrate circuits emerges that replaces current integrated circuits, one or more aspects of the present disclosure may possibly utilize the new integrated circuits provided by such technology.

What is claimed is:

1. An image forming apparatus comprising:
a display that displays an operational screen of the image forming apparatus; and
one or more controllers that control execution of an input job, wherein
when a printing job is input, the one or more controllers determine a display form of an operational object for receiving a stop instruction for that printing job, and display, on the operational screen, the operational object that is based on determined the display form.

2. The image forming apparatus according to claim 1, wherein
the operational screen includes a first display area, and a second display area which is larger, in display area, than the first display area, and
the one or more controllers display, on the first display area, the operational object that is based on the determined display form.

3. The image forming apparatus according to claim 1, wherein
the one or more controllers determine, as the display form of the operational object, any of an operational object name, an icon, or a combination of the operational object name and the icon.

4. The image forming apparatus according to claim 3, wherein
when the image forming apparatus is executing a specific job, the one or more controllers determine the display form of the operational object, to be the icon, and
when the image forming apparatus is not executing a specific job, the one or more controllers determine the display form of the operational object, to be the operational object name.

5. The image forming apparatus according to claim 4, wherein
the specific job is a job related to transmission of image information.

6. The image forming apparatus according to claim 1, wherein
when no operation is performed via the operational screen, the one or more controllers display a message screen including the operational object, on the operational screen.

7. The image forming apparatus according to claim 2, wherein
the first display area has a display area that is 20% or less of a total display area of the operational screen.

8. An operational object display method comprising:
displaying an operational screen of an image forming apparatus;
controlling execution of an input job; and
when a printing job is input, determining a display form of an operational object for receiving a stop instruction for that printing job, and displaying, on the operational screen, the operational object that is based on determined the display form.
